(19) United States
(12) Patent Application Publication
(10) Pub. No.: US 2024/0007447 A1
(43) Pub. Date: Jan. 4, 2024

(54) OFFLINE END-TO-END ENCRYPTION WITH PRIVACY

(71) Applicant: ASSA ABLOY AB, Stockholm (SE)

(72) Inventor: Martin Kaufmann, Graz (AT)

(21) Appl. No.: 18/253,102

(22) PCT Filed: Nov. 18, 2020
(86) PCT No.: PCT/EP2020/082530

§ 371 Date: May 16, 2023

(51) Int. Cl. H04L 9/40; H04L 9/14

(52) U.S. Cl. CPC H04L 63/0435; H04L 9/14

(57) ABSTRACT

A method of device authentication comprises transmitting a data stream from a first endpoint device to a second endpoint device. The data stream includes a first data stream portion including unencrypted data that includes an ephemeral public key of an ephemeral key pair, and an encryption algorithm identifier; a second data stream portion including encrypted data that includes a first counter value and an identity of the first endpoint device; and a third data stream portion including encrypted data that includes a second counter value and an identity of the second endpoint device. The method of device authentication further comprises the second endpoint device authenticating the first endpoint device using the first, second, and third data stream portions.

### TECHNICAL FIELD

Embodiments illustrated and described herein generally relate to automatic identity authentication systems that authenticate users for access to secure resources, and to techniques of secure messaging for identity authentication systems.

### BACKGROUND

There are many applications for which quick and accurate authentication of identity between devices is desirable. Some examples include airline travel and secure access to controlled areas. Additionally, remote identity authentication for applications such as mobile online shopping or mobile banking is now a common practice. Device authentication can involve authentication information being exchanged between a server performing authentication and a credential device such as a smart card or a mobile phone. Device authentication can also involve authentication information being exchanged between an Internet of Things (IoT) device and a server or mobile phone. Secure messaging is used to enable transfer of sensitive information used in the authentication process.

### BRIEF DESCRIPTION OF THE DRAWINGS

FIG. 1 is an illustration of an example of portions of an authentication system.

FIG. 2 is a flow diagram of an example of a method of device authentication.

FIG. 3 is a diagram of an example of the data stream transmitted for device authentication.

FIG. 4 is an example of a first portion of the data stream in FIG. 3.

FIG. 5 is an example of a second portion of the data stream in FIG. 3.

FIG. 6 is an example of a third portion of the data stream in FIG. 3.

FIG. 7 is a block diagram schematic of portions of an example of an endpoint device.

### DETAILED DESCRIPTION

It is often desirable for communication between devices to be fast and secure. For example, secure communication may involve messaging to send sensitive identification information between a verifier device (e.g., a system server of an authentication system backend) and credential device (e.g., a smartcard or smartphone). The sensitive information is encrypted using encryption keys. A key agreement scheme between the endpoint devices allows for encryption and decryption by both devices.

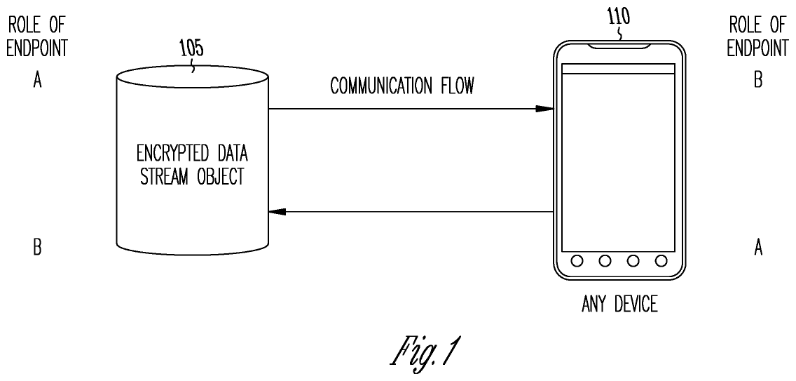

FIG. 1 is an illustration of an example of endpoint devices 105, 110 that can communicate using secure messaging. In the example, endpoint device 105 is a system server of an authentication system backend and the endpoint device 110 is a smartphone, but the endpoint devices can be any two devices that use secure messaging and authentication of one or both of the devices is needed.

Endpoint device 105 may be a verifier device and endpoint device 110 may be a credential device that may store an access credential that provides controlled access to a resource such as a financial resource or a secured physical space. Authentication messaging is used to verify that the access credential provides the desired access. In another example, authentication may involve messaging between an Internet of Things (IoT) device (e.g., a smart access lock) and a server or a smartphone. The server may need authentication to download firmware to the IoT device, or the IoT device may need to upload a history of events to the server. The communication of sensitive information in these examples should be secure.

The communication can be made secure using one or more session keys or encryption keys 115 to encrypt the messages of a communication session between the devices. This is especially true if there are intermediate devices that relay the information and it is desired to avoid exposing the data to the relaying devices. The keys can be shared according to a communication protocol. However, it is possible that one of the devices is offline when the communication needs to take place. The offline device could be any of the examples of a verifier device, credential device, server, smartphone or IoT device. It would be useful for a communication protocol for exchanging key information when one of the devices is offline and to encrypt the data sent to the offline device without contacting the offline device beforehand. Because it is desired to not use a lot of static secret keys, asymmetric cryptography based on asymmetric keys can be used.

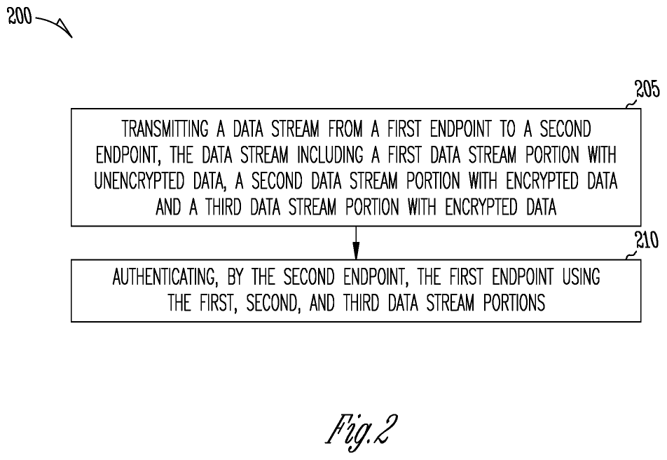

FIG. 2 is a flow diagram of a method 200 of secure communication between two endpoint devices of an authentication system. The endpoint devices are referred to as Endpoint A and Endpoint B. Any of the devices described herein in regard to FIG. 1 may be either the Endpoint A device or the Endpoint B device. For the IoT example, an IoT device (or any wireless device) may be either Endpoint A or Endpoint B and a server may be the other of either Endpoint A or Endpoint B. The identities of both endpoints are known up front. At block 205, a data stream is transmitted from Endpoint A to Endpoint B. Endpoint B is initially offline.

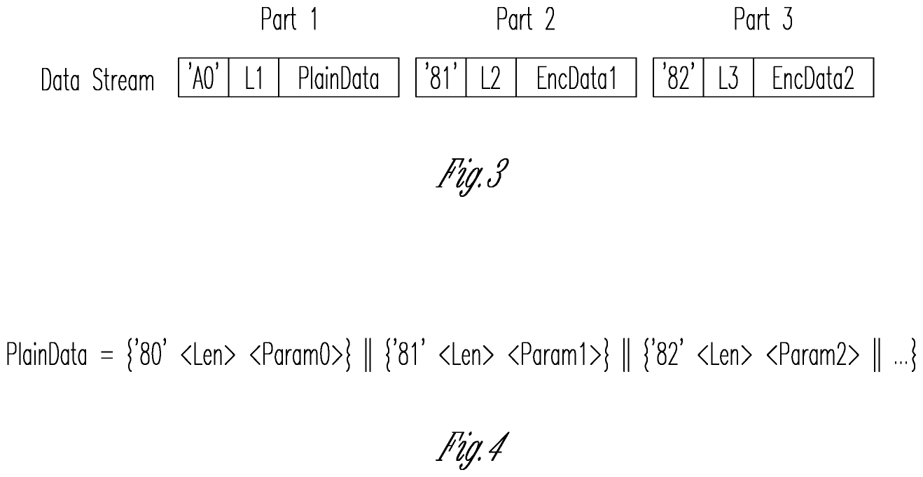

FIG. 3 is a diagram of an example of the data stream. Endpoint A sends the data stream and only Endpoint B decodes the data stream. The data stream includes three portions. The first data stream portion includes unencrypted data (PlainData) and the second and third portions include encrypted data; EncData1 and EncData2, respectively. Returning to FIG. 2 at block 210, Endpoint B authenticates Endpoint A using the three data stream portions.

Endpoint A holds or stores the following information;
An Endpoint A device asymmetric Key Pair K_{A}=(SK_{A}, PK_{A}), where SK_{A} is a secret key and PK_{A} is a public key.
An identity of Endpoint A. The identity may be the public key (PK_{A}) or a certificate Cert_{A} that can be the public key signed by a certification authority (CA) (Cert_{A}=Cert(PK_{CA}, PK_{A})). The certificate proves that Endpoint A is an approved endpoint.
An identity of Endpoint B that can be the public key (PK_{B}).

Endpoint B holds the following information:
An Endpoint B device asymmetric Key Pair K_{B}=(SK_{B}, PK_{B}), where SK_{B} is a secret key and PK_{B} is a public key.
An identity of Endpoint B. The identity can be the public key (PK_{B}).

This information held by the endpoints is used to generate data included in the data stream.

FIG. 4 is an example of the unencrypted data (PlainData) of the first portion of the data stream of FIG. 3. The PlainData holds parameters related to the encryption algorithm used to encrypt the data in the second and third data portions. In the example of FIG. 4, each parameter sent in the first portion of the data stream is given a Basic Encoding Rule TAG Length and Value (BER-TLV) primitive tag number. Any number of parameters can be sent in the first portion of the data stream.

The parameters include an encryption algorithm identifier. For example, this parameter may identify that the algorithm includes an asymmetric algorithm for key generation and a symmetric algorithm for encryption and integrity protection. The parameters also include an ephemeral public key (PK_{e,A}) of an ephemeral key pair (PK_{e,A},SK_{e,A}) that is generated by processing circuitry of Endpoint A.

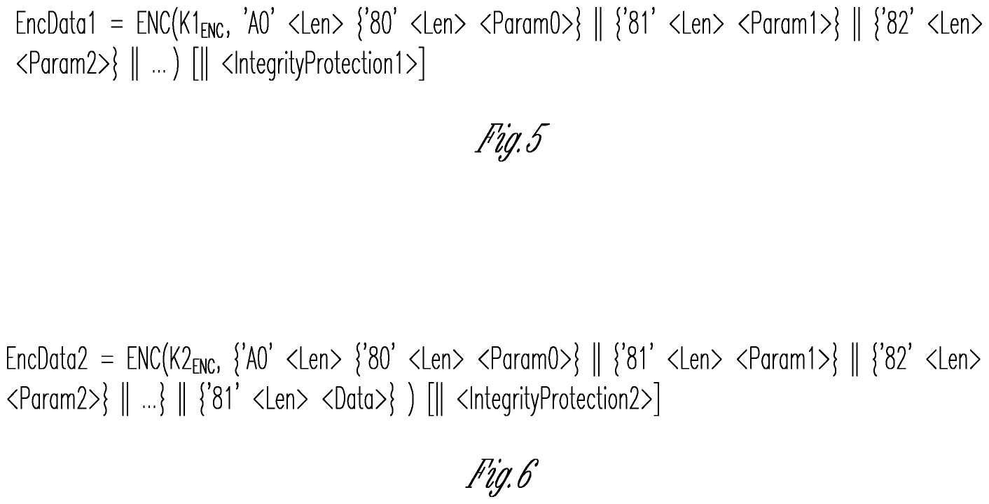

FIG. 5 is an example of the encrypted data (EncData1) of the second portion of the data stream of FIG. 3. EncData1 includes a constructed object holding a list of one or more parameters in an encrypted way. The second data stream portion includes a key (K1_{ENC}) of a first set of symmetric encryption keys (K1_{ENC}, K1_{MAC}). Each Endpoint calculates the keys. As an example, Endpoint A calculates the symmetric encryption keys as

Z₁=ECDH(SK_{e,A},PK_{B}), and

K1_{ENC},K1_{MAC}=EEKD(Salt,f(L,[IV1,] FixedInfo1),Z₁),

where ECDH is Elliptic Curve Diffie Hellman operation using Secret Key (SK_{e.A}) and Public Key (PK_{B}), but other asymmetric algorithms can be used. EEKD is an extraction-then expansion key-derivation procedure where
Key-derivation key (K_{DK})=RandomnessExtraction (Salt,Z), where Salt is “Salt data” (e.g., random data), and
DerivedKeyMaterial=KeyExpansion(K_{DK}, f(L, [IV,] FixedInfo)).

Other session key calculation algorithms can be used. As explained previously herein, Endpoint A holds a copy of public key (PK_{B}) of Endpoint B. Endpoint B calculates the symmetric encryption keys as

Z₁=ECDH(SK_{B},PK_{e,A}), and

K1_{ENC},K1_{MAC}=EEKD(Salt,f(L,[IV1,]FixedInfo1),Z₁).

Ephemeral public key (PK_{e,A}) was included in the PlainData of the first data stream portion.

Because each Endpoint knows the symmetric encryption keys, Endpoint A can encrypt the second data stream portion (EncData1 of FIG. 5), Endpoint B can decrypt the second data stream portion, and thus Endpoint A can communicate in an encrypted manner with, or otherwise send encrypted data to, Endpoint B. In the example of FIG. 5, each parameter (<ParamX>) sent in the second data stream portion is given a BER-TLV primitive tag number. Any number of parameters can be sent in the second data stream portion. The parameters of the second data stream portion may include a value of a counter and an indication of the identity of Endpoint A. The counter is to guard against the data stream being used or received by Endpoint B more than once. The identity of Endpoint A can be a public key PK_{A} of a public/secret key pair of Endpoint A (PK_{A},SK_{A}) and is included in the parameters of the second data stream portion. In some aspects, the identity of the Endpoint A can be the public key of the first endpoint signed by a certification authority (PK_{CA}). As shown in the example of FIG. 5, the second data stream portion can include separate integrity data (<IntegrityProtectionX>) to protect the integrity of the data in the second data stream portion. The integrity data can include cipher-based message authentication code (CMAC) or data of a symmetric algorithm with similar security strength.

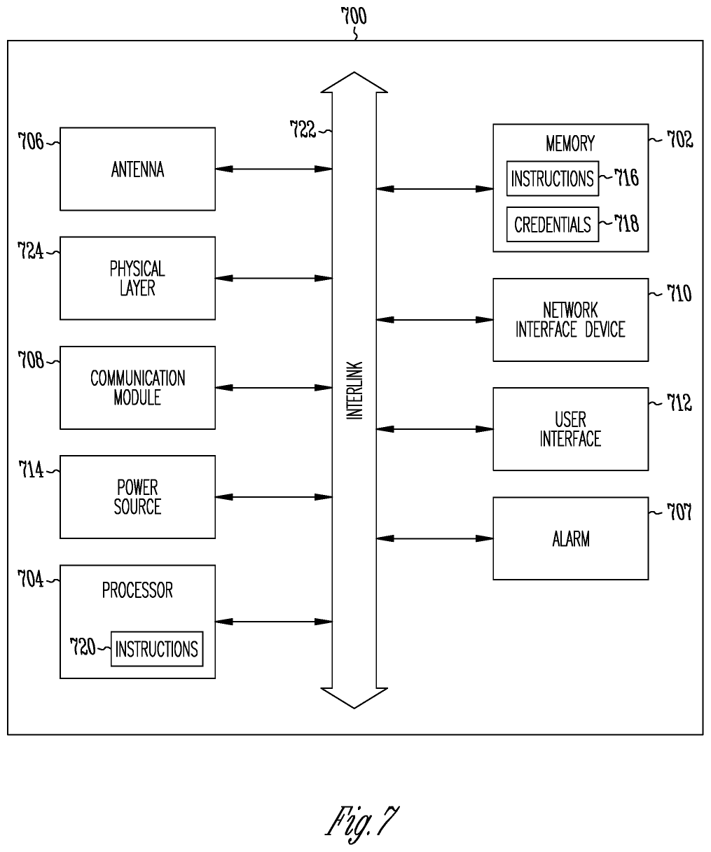

FIG. 6 is an example of the encrypted data (EncData2) of the third portion of the data stream of FIG. 3. EncData2 includes a constructed object holding a list of parameters in an encrypted way and a primitive object holding the data in an encrypted way. The third data stream portion includes one key (K2_{ENC}) of a second set of symmetric encryption keys (K2_{ENC}, K2_{MAC}). Each Endpoint calculates the keys (K2_{ENC}, K2_{MAC}). As an example, Endpoint A calculates the second symmetric encryption keys as

Z₂=ECDH(SK_{A},PK_{B}),

or another asymmetric algorithm, and

K2_{ENC},K2_{MAC}=EEKD(Salt,f(L,[IV1,]FixedInfo2),Z₁∥Z₂),

and Endpoint B calculates the second symmetric encryption keys as

Z₂=ECDH(SK_{B},PK_{A}), and

K2_{ENC},K2_{MAC}=EEKD(Salt,f(L,[IV1,]FixedInfo1),Z₁∥Z₂).

Because each Endpoint knows the second symmetric encryption keys, Endpoint A can encrypt the third data stream portion (EncData2 of FIG. 6), Endpoint B can decrypt the third data stream portion, and Endpoint A can communicate in an encrypted manner with Endpoint B. Like the second data stream portion, each parameter (<ParamX>) sent in the third data stream portion is given a BER-TLV primitive tag number, and any number of parameters can be sent in the third data stream portion. The parameters of the third data stream portion may include a value of a counter and an indication of the identity of Endpoint B. The identity of Endpoint B can be the public key PK_{B} of Endpoint B held by Endpoint A. The identity of Endpoint A is authenticated by Endpoint B using the data of the data stream decrypted using the symmetric encryption keys.

The systems, devices, and methods described herein provide secure communication of sensitive information between the endpoint devices even when one of the devices is initially offline. One use case example for the systems, methods, and devices described herein is a server and an electronic lock or smart lock. Secure communication between the devices may be in either direction. The electronic lock may receive and determine encryption keys when the server downloads firmware for operation of the electronic lock, and the electronic lock may send encryption keys to the server when the electronic lock uploads access history to the server. In another use case example, a reader device authenticates a user's mobile phone for physical access to a controlled area.

FIG. 7 is a block diagram schematic of various example components of an endpoint device 700 for supporting the device architectures described and illustrated herein. The endpoint device 700 of FIG. 7 could be, for example, a verifier device that authenticates credential information of authority, status, rights, and/or entitlement to privileges for the holder of a credential device. The endpoint device may be a server of the backend of an authentication system. In variations, the endpoint device may be an electronic lock or other IoT device. In other variations, the endpoint device may be a reader device of a physical access control system (PACS). A reader device of a PACS retrieves and authenticates an access credential when a credential device is used and sends the access credential to an access controller. The access controller compares the access credential to an access control list and grants or denies access based on the comparison, such as by controlling an automatic lock on a door for example. In variations, the reader device performs the functions of the access controller.

With reference specifically to FIG. 7, additional examples of a device 700 for supporting the device architecture described and illustrated herein may generally include one or more of a memory 702, processing circuitry such as processor 704, one or more antennas 706, a communication port or communication module 708, a network interface device 710, a user interface 712, and a power source 714 or power supply.

Memory 702 can be used in connection with the execution of application programming or instructions by processing circuitry, and for the temporary or long-term storage of program instructions or instruction sets 716 and/or authorization data 718, such as credential data, credential authorization data, or access control data or instructions, as well as any data, data structures, and/or computer-executable instructions needed or desired to support the above-described device architecture. For example, memory 702 can contain executable instructions 716 that are used by a processor 704 of the processing circuitry to run other components of device 700, to calculate encryption keys to communicate credential or authorization data 718, and/or to perform any of the functions or operations described herein, such as the method of FIG. 2 for example. Memory 702 can comprise a computer readable medium that can be any medium that can contain, store, communicate, or transport data, program code, or instructions for use by or in connection with device 700. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

The processing circuitry of the device 700 is configured (e.g., by firmware) to perform the functions of verifier devices described herein. Such as the functions of the example method of FIG. 2. The processing circuitry can correspond to one or more computer processing devices or resources. For instance, processor 704 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 704 can be provided as a microprocessor, Central Processing Unit (CPU), or plurality of microprocessors or CPUs that are configured to execute instructions sets stored in an internal memory 720 and/or memory 702.

Antenna 706 can correspond to one or multiple antennas and can be configured to provide for wireless communications between device 700 and another device. Antenna(s) 706 can be operatively coupled to physical layer circuitry comprising one or more physical (PHY) layers 724 to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. In an example, antenna 706 may include one or more antennas coupled to one or more physical layers 724 to operate using ultra-wide band (UWB) for in band activity/communication and Bluetooth (e.g., BLE) for out-of-band (OOB) activity/communication. However, any RFID or personal area network (PAN) technologies, such as the IEEE 502.15.1, near field communications (NFC), ZigBee, GSM, CDMA, Wi-Fi, etc., may alternatively or additionally be used for the OOB activity/communication described herein.

Device 700 may additionally include a communication module 708 and/or network interface device 710. Communication module 708 can be configured to communicate according to any suitable communications protocol with one or more different systems or devices either remote or local to device 700. Network interface device 710 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 710 can include an Ethernet port or other physical jack, a Wi-Fi card, a Network Interface Card (MC), a cellular interface (e.g., antenna, filters, and associated circuitry), or the like. In some examples, network interface device 710 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 706, communication module 708, and/or network interface device 710 or subcomponents thereof, may be integrated as a single module or device, function or operate as if they were a single module or device, or may comprise of elements that are shared between them.

User interface 712 can include one or more input devices and/or display devices. Examples of suitable user input devices that can be included in user interface 712 include, without limitation, one or more buttons, a keyboard, a mouse, a touch-sensitive surface, a stylus, a camera, a microphone, etc. Examples of suitable user output devices that can be included in user interface 712 include, without limitation, one or more LEDs, an LCD panel, a display screen, a touchscreen, one or more lights, a speaker, etc. It should be appreciated that user interface 712 can also include a combined user input and user output device, such as a touch-sensitive display or the like. The user interface 712 may include a separate alarm circuit 707 to indicate an alarm condition such as a security breach. Alarm circuit 707 may provide an audio signal to a speaker or may activate a light or present an alarm condition using a display device.

Power source 714 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the device 700.

Device 700 can also include one or more interlinks or buses 722 operable to transmit communications between the various hardware components of the device. A system bus 722 can be any of several types of commercially available bus structures or bus architectures.

### ADDITIONAL DISCLOSURE AND EXAMPLES

Example 1 includes subject matter (such as a method of device authentication) comprising transmitting a data stream from a first endpoint device to a second endpoint device. The data stream includes a first data stream portion including unencrypted data that includes an ephemeral public key of an ephemeral key pair, and at least one encryption algorithm identifier; a second data stream portion including encrypted data that includes a first counter value and an identity of the first endpoint device; and a third data stream portion including encrypted data that includes a second counter value and an identity of the second endpoint device. The second endpoint device authenticates the first endpoint device using the first, second, and third data stream portions.

In Example 2, the subject matter of Example 1 optionally includes transmitting a key of first symmetric encryption keys in the second data stream portion, wherein the first symmetric encryption keys are determined using an ephemeral secret key of the ephemeral key pair and a public key of the second endpoint device.

In Example 3, the subject matter of Example 2 optionally includes determining, by the second endpoint device, first symmetric encryption keys using the ephemeral public key of the first data stream portion and a secret key of a secret/public key pair of the second endpoint device that includes the public key of the second endpoint device.

In Example 4, the subject matter of one or both of Examples 2 and 3 optionally includes transmitting a key of second symmetric encryption keys in the third data stream portion, wherein the second symmetric encryption keys are determined using a secret key of a secret/public key pair of the first endpoint device and the public key of the second endpoint device.

In Example 5, the subject matter of Example 4 optionally includes authenticating, by the second endpoint device, the first endpoint device using the first and second symmetric encryption keys and keys received from the first endpoint device in the second data stream portion and the third data stream portion, wherein the second symmetric encryption keys are determined by the second endpoint device using the public key of the first endpoint device and a secret key of a secret/public key pair that includes the public key of the second endpoint device.

In Example 6, the subject matter of one or any combination of Examples 1-5 optionally includes the identity of the first endpoint device including a public key of a first public/secret key pair of the first endpoint device; and the identity of the second endpoint including a public key of a second public/secret key pair of the second endpoint device.

In Example 7, the subject matter of one or any combination of Examples 1-5 optionally includes the identity of the first endpoint device includes a public key of a first public/secret key pair of the first endpoint signed by a certification authority.

In Example 8, the subject matter of one or any combination of Examples 1-7 optionally includes an encryption algorithm identifier that identifies an asymmetric encryption algorithm.

In Example 9, the subject matter of one or any combination of Examples 1-7 optionally includes an encryption algorithm identifier that identifies a symmetric encryption algorithm.

Example 10 includes subject matter (such as an endpoint device of an authentication system) or can optionally be combined with one or any combination of Examples 1-9 to include such subject matter, comprising physical layer circuitry and processing circuitry operatively coupled to the physical layer circuitry. The processing circuitry is configured to encode a data stream for transmitting by the physical layer circuitry to another endpoint of the authentication system. The data stream includes a first data stream portion including unencrypted data that includes an ephemeral public key of an ephemeral key pair, and at least one encryption algorithm identifier; a second data stream portion including encrypted data that includes a first counter value and an identity of the endpoint; and a third data stream portion including encrypted data that includes a second counter value and an identity of the other endpoint.

In Example 11, the subject matter of Example 10 optionally includes processing circuitry configured to generate first symmetric encryption keys using an ephemeral secret key of the ephemeral key pair and a public key of the other endpoint, and include a key of the first symmetric encryption keys in the second data stream portion.

In Example 12, the subject matter of Example 11 optionally includes processing circuitry configured to generate second symmetric encryption keys using a secret key of a secret/public key pair of the endpoint, and the public key of the other endpoint, and include a key of the second symmetric encryption keys in the third portion of the data stream.

In Example 13, the subject matter of one or any combination of Examples 10-12 optionally includes processing circuitry configured to include a public key of a first public/secret key pair of the endpoint as the identity of the endpoint in the second data stream portion, and a public key of a second public/secret key pair of the other endpoint public key as the identity of the other endpoint in the third portion of the data stream.

In Example 14, the subject matter of one or any combination of Examples 10-13 optionally includes processing circuitry configured to include a public key of a first public/secret key pair of the endpoint signed by a certification authority as the identity of the endpoint in the second data stream portion.

In Example 15, the subject matter of one or any combination of Examples 10-14 optionally includes at least one encryption algorithm identifier that identifies an asymmetric encryption algorithm.

In Example 16, the subject matter of one or any combination of Examples 10-14 optionally includes at least one encryption algorithm identifier that identifies a symmetric encryption algorithm.

Example 17 includes subject matter (such as an authenticating endpoint device of an authentication system) or can optionally be combined with one or any combination of Examples 1-16 to include such subject matter, comprising physical layer circuitry and processing circuitry operatively coupled to the physical layer circuitry. The processing circuitry is configured to receive a data stream from another endpoint of the authentication system. The data stream includes a first data stream portion including unencrypted data that includes an ephemeral public key of an ephemeral key pair, and at least one encryption algorithm identifier; a second data stream portion including encrypted data that includes a first counter value and an identity of the other endpoint; and a third data stream portion including encrypted data that includes a second counter value and an identity of the authenticating endpoint. The processing circuitry is further configured to authenticate the other endpoint using the first, second, and third data stream portions.

In Example 18, the subject matter of Example 17 optionally includes physical layer circuitry configured to receive a key of first symmetric encryption keys in the second data stream portion, and processing circuitry configured to generate the first symmetric encryption keys using the ephemeral public key of the first data stream portion and a secret key of a secret/public key pair of the second endpoint that includes the public key of the other endpoint.

In Example 19, the subject matter of Example 18 optionally includes physical layer circuitry configured to receive a key of second symmetric encryption keys in the third data stream portion, and processing circuitry configured to generate the second symmetric encryption keys using a secret key of a secret/public key pair of the authenticating endpoint, and the public key of the other endpoint, and authenticate the other endpoint using the first and second generated symmetric encryption keys and keys received from.

In Example 20, the subject matter of one or any combination of Examples 17-19 optionally includes the identity of the other endpoint including a public key of a first public/secret key pair of the other endpoint device; and the identity of the authenticating endpoint including a public key of a second public/secret key pair of the authenticating endpoint.

These non-limiting Examples can be combined in any permutation or combination. The above detailed description includes references to the accompanying drawings, which form a part of the detailed description. The drawings show, by way of illustration, specific embodiments in which the invention can be practiced. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A method of device authentication, the method comprising:
transmitting a data stream from a first endpoint device to a second endpoint device, wherein the data stream includes:
a first data stream portion including unencrypted data that includes an ephemeral public key of an ephemeral key pair, and at least one encryption algorithm identifier;
a second data stream portion including encrypted data that includes a first counter value and an identity of the first endpoint device; and
a third data stream portion including encrypted data that includes a second counter value and an identity of the second endpoint device; and
authenticating, by the second endpoint device, the first endpoint device using the first, second, and third data stream portions.

2. The method of claim 1, including:
transmitting a key of first symmetric encryption keys in the second data stream portion, wherein the first symmetric encryption keys are determined using an ephemeral secret key of the ephemeral key pair and a public key of the second endpoint device.

3. The method of claim 2, including determining, by the second endpoint device, first symmetric encryption keys using the ephemeral public key of the first data stream portion and a secret key of a secret/public key pair of the second endpoint device that includes the public key of the second endpoint device.

4. The method of claim 2, including:
transmitting a key of second symmetric encryption keys in the third data stream portion, wherein the second symmetric encryption keys are determined using a secret key of a secret/public key pair of the first endpoint device and the public key of the second endpoint device.

5. The method of claim 4, including:
authenticating, by the second endpoint device, the first endpoint device using the first and second symmetric encryption keys and keys received from the first endpoint device in the second data stream portion and the third data stream portion, wherein the second symmetric encryption keys are determined by the second endpoint device using the public key of the first endpoint device and a secret key of a secret/public key pair that includes the public key of the second endpoint device.

6. The method of claim 1, wherein the identity of the first endpoint device includes a public key of a first public/secret key pair of the first endpoint device; and the identity of the second endpoint includes a public key of a second public/secret key pair of the second endpoint device.

7. The method of claim 1, wherein the identity of the first endpoint device includes a public key of a first public/secret key pair of the first endpoint signed by a certification authority.

8. The method of claim 1, wherein the encryption algorithm identifier identifies an asymmetric encryption algorithm.

9. The method of claim 1, wherein the encryption algorithm identifier identifies a symmetric encryption algorithm.

10. An endpoint device of an authentication system, the device comprising:
physical layer circuitry; and
processing circuitry operatively coupled to the physical layer circuitry and configured to:
encode a data stream for transmitting by the physical layer circuitry to another endpoint of the authentication system, wherein the data stream includes:
a first data stream portion including unencrypted data that includes an ephemeral public key of an ephemeral key pair, and at least one encryption algorithm identifier;
a second data stream portion including encrypted data that includes a first counter value and an identity of the endpoint; and
a third data stream portion including encrypted data that includes a second counter value and an identity of the other endpoint.

11. The endpoint device of claim 10, wherein the processing circuitry is configured to:
generate first symmetric encryption keys using an ephemeral secret key of the ephemeral key pair and a public key of the other endpoint; and
include a key of the first symmetric encryption keys in the second data stream portion.

12. The endpoint device of claim 11, wherein the processing circuitry is configured to:
generate second symmetric encryption keys using a secret key of a secret/public key pair of the endpoint, and the public key of the other endpoint; and
include a key of the second symmetric encryption keys in the third portion of the data stream.

13. The endpoint device of claim 10, wherein the processing circuitry is configured to include a public key of a first public/secret key pair of the endpoint as the identity of the endpoint in the second data stream portion, and a public key of a second public/secret key pair of the other endpoint public key as the identity of the other endpoint in the third portion of the data stream.

14. The endpoint device of claim 10, wherein the processing circuitry is configured to include a public key of a first public/secret key pair of the endpoint signed by a certification authority as the identity of the endpoint in the second data stream portion.

15. The endpoint device of claim 10, wherein the at least one encryption algorithm identifier identifies an asymmetric encryption algorithm.

16. The endpoint device of claim 10, wherein the at least one encryption algorithm identifier identifies a symmetric encryption algorithm.

17. An authenticating endpoint device of an authentication system, the device comprising:
physical layer circuitry; and
processing circuitry operatively coupled to the physical layer circuitry and configured to:
receive a data stream from another endpoint of the authentication system, wherein the data stream includes:
a first data stream portion including unencrypted data that includes an ephemeral public key of an ephemeral key pair, and at least one encryption algorithm identifier;
a second data stream portion including encrypted data that includes a first counter value and an identity of the other endpoint; and
a third data stream portion including encrypted data that includes a second counter value and an identity of the authenticating endpoint; and
authenticate the other endpoint using the first, second, and third data stream portions.

18. The authenticating endpoint device of claim 17,
wherein the physical layer circuitry is configured to receive a key of first symmetric encryption keys in the second data stream portion; and
wherein the processing circuitry is configured to generate the first symmetric encryption keys using the ephemeral public key of the first data stream portion and a secret key of a secret/public key pair of the second endpoint that includes the public key of the other endpoint.

19. The authenticating endpoint device of claim 18, including:
wherein the physical layer circuitry is configured to receive a key of second symmetric encryption keys in the third data stream portion; and
wherein the processing circuitry is configured to:
generate the second symmetric encryption keys using a secret key of a secret/public key pair of the authenticating endpoint, and the public key of the other endpoint; and
authenticate the other endpoint using the first and second generated symmetric encryption keys and keys received from the other endpoint in the second data stream portion and the third data stream portion.

20. The authenticating endpoint device of claim 17, wherein the identity of the other endpoint includes a public key of a first public/secret key pair of the other endpoint device; and the identity of the authenticating endpoint includes a public key of a second public/secret key pair of the authenticating endpoint.
